(19) United States
(12) Patent Application Publication
(10) Pub. No.: US 2014/0009404 A1
(43) Pub. Date: Jan. 9, 2014

(54) Portable Computing Device

(71) Applicant: Yang Pan, Singapore (SG)

(72) Inventor: Yang Pan, Singapore (SG)

(21) Appl. No.: 13/543,903

(22) Filed: Jul. 9, 2012

(51) Int. Cl. G06F 1/16; G06F 3/041

(52) U.S. Cl. 345/173; 361/679.26; 361/679.27

(57) ABSTRACT

A portable computing device comprises a covering part, a housing part and a connecting part. The covering part includes a first display screen. The housing part includes a second display screen which is a touch sensitive type. The device is operated as a laptop or palmtop computer when the first display screen is positioned to facing the second display screen by the connecting unit. The second display screen displays a virtual keyboard for receiving a user's inputs. The covering part may be retracted inside an open slot of the housing part and the device is then operated as a tablet computer.

### CROSS-REFERENCE TO RELATED APPLICATIONS

Not applicable.

### BACKGROUND

1. Field of Invention

This invention relates generally to a portable computing device. More specifically, the invention describes a portable computing device with a retractable display screen.

### BACKGROUND

2. Description of Prior Art

A laptop computer is a personal computer for mobile use. A laptop computer integrates most of components of a desktop computer and is used for general computing. Laptops are also sometimes called notebook or netbook computers. It has been a great challenge to minimize power consumption of the laptop computer and to increase its battery operation time.

A tablet computer refers to a slate shaped portable computing device, equipped with a touch sensitive type of display screen. A user operates the device by the use of his or her finger or a stylus. Because it is very portable, tablet computers are rapidly gaining popularity. However, the tablet computer due to lack of a keyboard may not be best suited for applications such as, for example, word processing. A tablet computer consumes typically less power than a laptop computer.

Therefore, there is a need to integrate a laptop computer and a tablet computer into a single piece of portable device while minimizing power consumption and increasing operation time of a battery.

### SUMMARY OF THE INVENTION

It is an object of the present invention to provide a portable computing device that can be used as a laptop or palmtop computer with a keyboard in one occasion and as a tablet computer in another occasion.

According to a preferred embodiment of the present invention, a portable computing device comprises a covering part, a housing part and a connecting part. The covering part includes a first display screen. The housing part includes a second display screen. The second display screen is a touch sensitive type of display. The connecting part is a hinge part in one implementation and is a magnetic connecting part in another implementation.

The portable computing device is operated as a laptop or a palmtop computer when the first display screen is positioned to facing the second display screen. The second display screen displays a virtual keyboard for receiving a user's inputs. The housing part includes an open slot. The covering part may be retracted into the open slot through the use of the hinge part and other necessary mechanical parts. The portable device can then be used as a tablet computer. The second display screen is served as a touch sensitive display screen for the tablet computer.

The covering part may be positioned on top face of the housing part with the first display screen facing down. The arrangement protects display screens when the device is ported from one place to another place.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram illustrating an exemplary portable computing device operated as a laptop computer (FIG. 1A-1C) and as a tablet computer (FIG. 1D).

FIG. 2 is a schematic diagram illustrating functional blocks of an exemplary implementation of the portable computing device.

FIG. 3 is a flowchart illustrating operation of an exemplary portable computing device.

### DETAILED DESCRIPTION

References will now be made in detail to a few embodiments of the invention, examples of which are illustrated in the accompanying drawings. While the invention will be described in conjunction with the particular embodiments, it will be understood that it is not intended to limit the invention to the described embodiments. To the contrary, it is intended to cover alternatives, modifications, and equivalents as may be included within the spirit and scope of invention as defined by the appended claims.

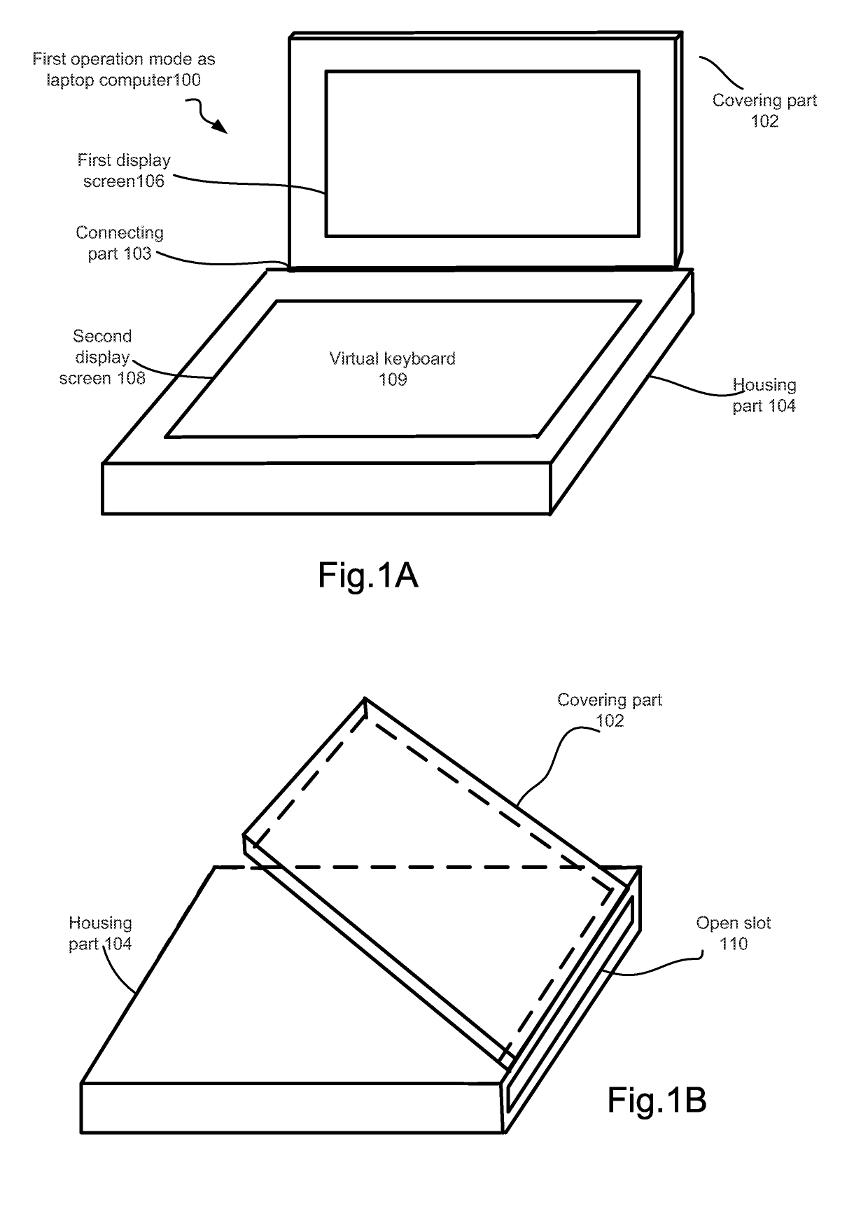

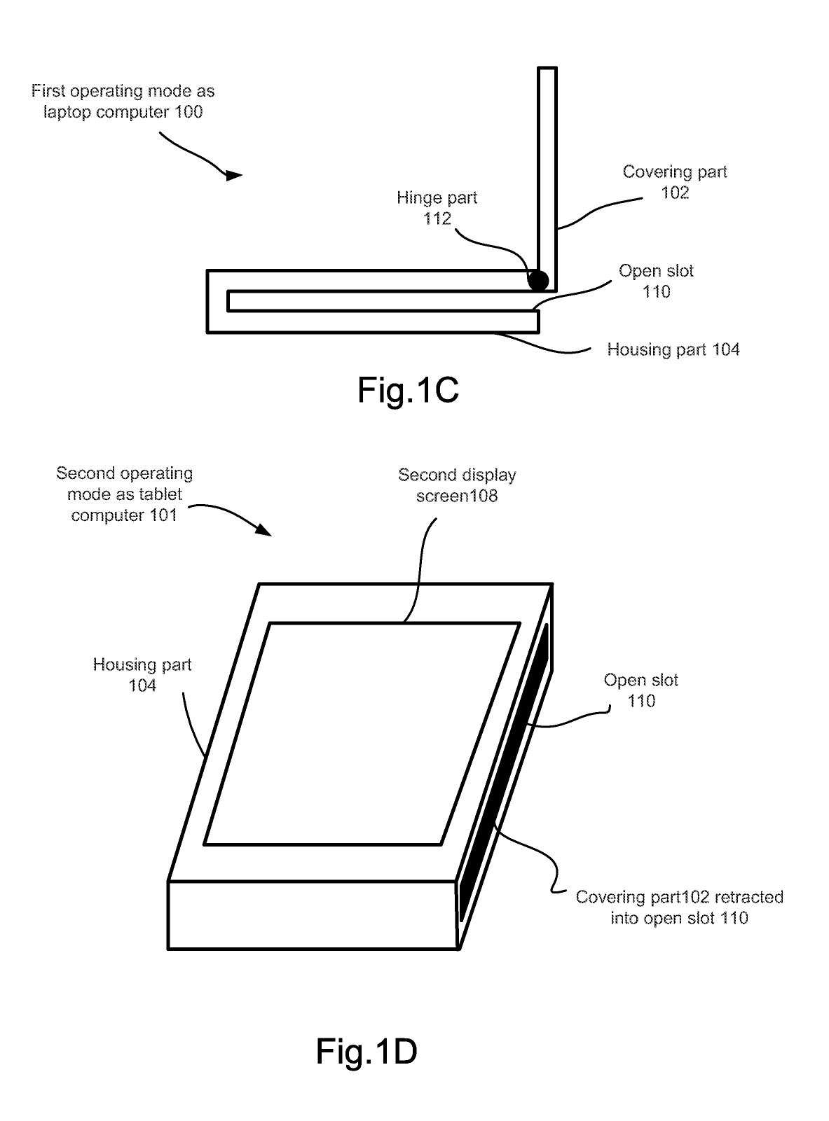

FIG. 1A-D is a schematic diagram illustrating an exemplary portable computing device. FIG. 1A illustrates a first operating mode as a laptop computer 100. The portable computing device comprises a covering part 102 and a housing part 104. Covering part 102 and housing part 104 are connected by a connecting part 103. In one implementation, connection part 103 is a hinge part. The hinge part may be used to position covering part 102 to a position for the portable device to be operated as a laptop computer. The hinge part may also be used to position covering part 102 to be on top of housing part 104. Covering part 102 will then become a protection part for housing part 104. In another implementation, connecting part 103 is a magnetic connecting part. Covering part 102 and housing part 104 may be connected by using a magnetic force generated by a pair of magnets located in covering part 102 and in housing part 104, respectively.

Although a laptop computer is employed to illustrate the inventive concept, the portable computing may take any form of a portable computing device that includes but is not limited to a palmtop computer and a smart phone.

Covering part 102 further includes a first display screen 106. First display screen 106 may be a Liquid Crystal Display (LCD). First display screen 106 may also be an Organic Crystal Display (OLCD). First display screen 106 may also be an e-paper type of display that display. Covering part 102 with first display screen 106 may take a solid form factor. Covering part 102 with first display screen may also take a bendable form factor.

When the portable computing device is operated as a laptop computer as shown in FIG. 1A, second display screen 108 displays a virtual keyboard 109. In a preferred embodiment, second display screen 108 is a touch sensitive type of display. A user operates the portable computing device as a laptop computer using virtual keyboard 109 and first display screen 106.

The portable computing device further includes an open slot 110 in housing part 104 as shown in FIG. 1B. Covering part 102 may be retracted into open slot 110 by the use of a hinge part and other necessary mechanical parts. Mechanical parts for retracting a part inside another part are well known in the art.

Hinge part 112 is illustrated in FIG. 1C as an exemplary implementation of connection part 103. Display part 102 may be slightly narrower in order for the part to be retracted inside open slot 110. In an exemplary case, display part 102 may be 0.1 to 5 mm narrower than housing part 104.

After covering part 102 is retracted inside housing part 104, the portable computing device may be used as a tablet computer 101 as shown in FIG. 1D. Second display screen 104 is used as a touch sensitive display screen for the tablet computer 101.

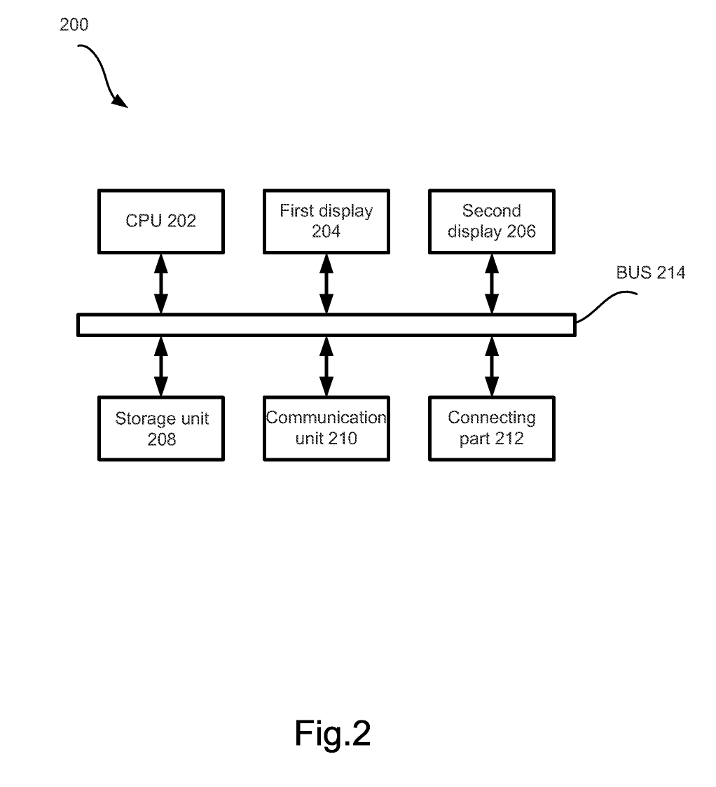

FIG. 2 is an exemplary functional blocks of the portable computing device. Device 200 comprises a Central Processing Unit (CPU) pertaining to controlling operation of the device. Device 200 further comprises first display 204 and second display 206. Second display 206 is touch sensitive and can be used to display a virtual keyboard. Exemplary portable device 200 further comprises a storage unit 208, a communication unit 210 and a connecting part 212. Storage unit 208 may include a semiconductor memory device such as for example a flash memory device. Communication unit 210 may include a transceiver for connecting the device to a communication network such as for example the Internet. It should be noted that the inclusion of communication unit 210 is not essential for the operation of the portable device. The portable computing device is fully functional without a communication unit. The device further includes a connecting unit 212 for connection covering part including first display 204 and housing part including second display 206.

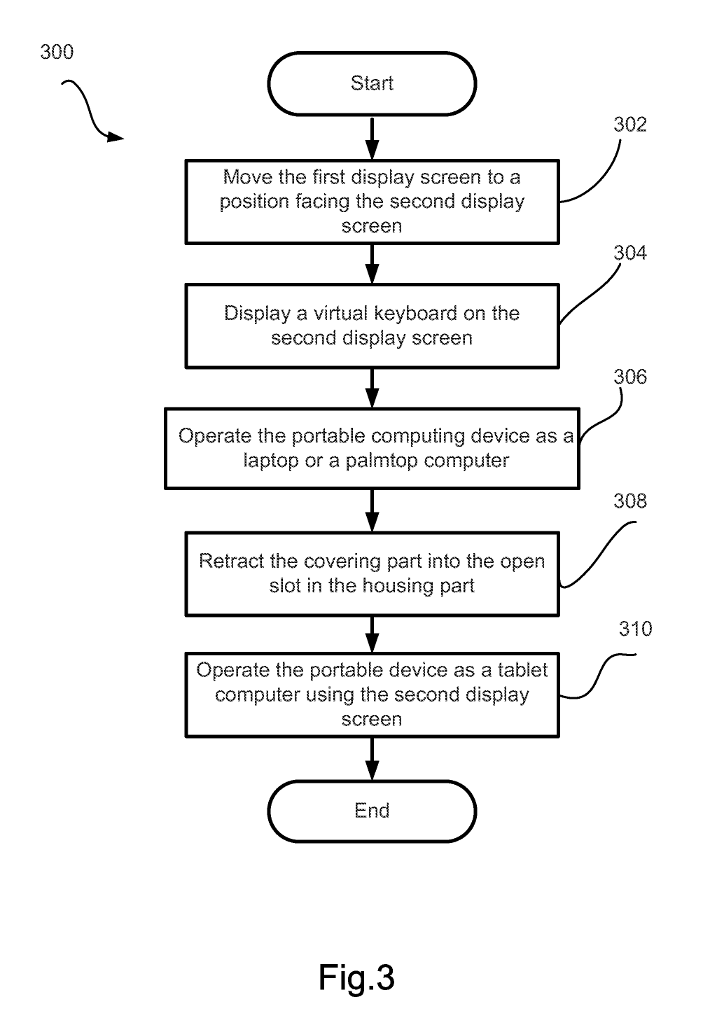

FIG. 3 is a flowchart illustrating exemplarily operation of the portable computing device. Process 300 starts with step 302 that covering part 102 is moved to a position by a user through connecting unit 103 that first display screen 106 is facing to second display screen 108 of housing part 104. A virtual keyboard is displayed on second display screen 108 by CPU of the device in step 304. The user operates the device as a laptop or a palmtop computer in step 306. Covering part 102 is retracted into open slot 110 of housing part 104 in step 308. The portable computing device is then operated as a tablet computer in step 310.

1. A portable computing device comprising:
a. a covering part having two surfaces, wherein one of the surfaces comprises a first display screen;
b. a housing part having two surfaces, wherein one of the surfaces comprises a second display screen, wherein said housing part further comprising a open slot for receiving the covering part;
c. a connecting part for connecting the covering part and the housing part; and
d. two operation modes including:
i. positioning the first displaying screen to facing the second display screen and displaying a virtual keyboard on the second display screen and operating the portable computing device as a laptop or palmtop computer; and
ii. retracting the covering part inside the housing part and operating said portable computing device as a tablet computer.

2. The device as recited in claim 1, wherein said second display screen is a touch sensitive type of display.

3. The device as recited in claim 1, wherein said device further comprising a Central Processing Unit, a storage unit and a communication unit.

4. The device as recited in claim 3, wherein said units are included in the housing part.

5. The device as recited in claim 1, wherein said connecting part further comprising a hinge part.

6. The device as recited in claim 1, wherein said connecting part further comprising a magnetic connecting part.
